(19) United States
(12) Patent Application Publication
(10) Pub. No.: US 2025/0193029 A1
(43) Pub. Date: Jun. 12, 2025

(54) METHOD FOR THE VALIDATION OF TRANSACTION DATA OF BLOCKCHAINS BASED ON SPECIAL RELATIVITY

(71) Applicants: Frederic DEGUILLAUME, Geneva (CH); Alexander HOBBS, Ruschlikon (CH); Miles TIMPE, Horgen (CH)

(72) Inventors: Frederic DEGUILLAUME, Geneva (CH); Alexander HOBBS, Ruschlikon (CH); Miles TIMPE, Horgen (CH)

(21) Appl. No.: 18/852,361

(22) PCT Filed: Mar. 31, 2023
(86) PCT No.: PCT/CH2023/050009

§ 371 Date: Sep. 27, 2024

Related U.S. Application Data
(60) Provisional application No. 63/326,343, filed on Apr. 1, 2022.

(51) Int. Cl. H04L 9/00; H04L 9/32

(52) U.S. Cl. CPC H04L 9/50; H04L 9/3247

(57) ABSTRACT

Proof-of-Work (PoW) is the most secure consensus mechanism to validate transaction data in public blockchains. However, there is an ever-growing criticism about the high energy demand of PoW-based cryptocurrencies. Bitcoin alone consumes (at the time of writing) roughly 2.5 times as much energy as Switzerland just to secure its network. Therefore, low energy-consuming consensus methods are required and preferred, and many recent cryptocurrencies now implement Proof-of-Stake (POS) as an alternative. However, PoS has some drawbacks as well, one of them being the requirement to immobilize coins for staking, and cannot be not as secure as PoW. An interesting and promising alternative is Proof-of-Elapsed-Time (PoET), relying on the random sleep/wake times of processing units. However, this is not totally satisfactory in its current incarnation, because it relies on protected areas of computing chips: this is only a technological protection that can be broken. The invention proposes a variant of PoET, called Space PoET, which uses the fact that no information can travel faster than the speed of light, according to Einstein's Special Theory of Relativity, imposing minimal information transmission delay: this is a fundamental protection. The method is based on transaction validation messages forced to pass through distinct hops to guarantee some elapsed time and security against manipulation of randomness generation. This makes the method ideal for satellite constellations in space, where distances are established by the laws of celestial mechanics.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not applicable

### BACKGROUND OF THE INVENTION

### The Characteristics of a Satellite-Based Network

Satellites in Low Earth Orbit (LEO) typically travel at around 17'500 mph or 28'000 km/h, resulting in an extremely dynamic network environment with respect to communications. Distances between satellites impose a minimum delay in inter-satellite communication, limited by the finite speed of light in a vacuum as stated by the theory of special relativity. For simplicity and clarity, “speed of light in vacuum” will be referred to as “speed of light” in the text that follows. Speed of satellites, relative to the ground and with respect to each other, further results in shifts in frequencies of electromagnetic waves used for communications, known as the Doppler effect. Finally, the rapidly varying distances between satellites and the speeds of individual satellites result in variations in the transmission delay of signals, or jitters. Communication can be direct between two satellites or relayed via ground-based stations. Consequently, inter-satellite and satellite-to-ground communications undergo latencies, Doppler effects, and jitters, which continuously change.

Latency: this is the amount of time for information to be transmitted from one node of the network to another. Latency exists in any network, including ground-based networks depending mostly on bandwidth, congestion, processing time at intermediate/relaying nodes, and on distances. Various optimizations can reduce latency. But what is interesting with satellites is that the latency part resulting from physical distances between satellites is significant, not less than tenths of milliseconds for Low Earth Orbit (LEO) satellites communicating directly.

Jitter: is the variation in time delay between when a signal is transmitted and when it is received over a network connection, measuring the variability in the duration of a “ping”. In networks, data is typically grouped together and transmitted as packets. Delays of packet transmission, depending on latency, is not constant. This results into Packet Delay Variation (PDV), also called jitter. This effect is potentially magnified in satellite networks, in comparison with ground-based wired network, due to the highly dynamical configuration of satellite constellations.

### Satellite Internet and Global Online Services

Latency, jitter and bandwidth variation of traditional ground-based cable and fiber networks mostly result from congestion. Latency can be reduced by increasing the bandwidth, for example by adding optical fibers. On Earth, the amount of latency resulting from distance is limited compared to other causes. Jitter can be made negligible, for example by protocol optimization. On the other hand, these disturbances differ radically in satellite networks.

Projects of satellite mega-constellations for worldwide Internet connectivity are emerging, responding to the expected increase in needs of connectivity in regions or in situations where no efficient ground-based connectivity is present. The most known examples of such projects are: the Starlink constellation from the US company SpaceX; the satellite network envisioned by the OneWeb company headquartered in London in UK; and Amazon's Kuiper envisioned satellite network. Latency and jitter are reduced, bandwidths increased, by placing a large number of LEO satellites (up to tens of thousands!) with strong direct inter-satellite communication capabilities.

### Public Blockchain Consensus

A blockchain is a repository that can store data in a way that makes it difficult or impossible to alter its content afterwards, to hack its established rules, or to cheat the system. A blockchain is essentially a digital ledger of transactions that is duplicated and distributed across an entire network of computer systems. A blockchain can be decentralized, meaning that no central authority is required to manage it, even in an unsecure environment like the Internet. The first official public and really decentralized blockchain has been invented by Satoshi Nakamoto in 2009 and applied to the first cryptocurrency, the Bitcoin [1]. In particular, this first public blockchain solved the problem of double-spending without the need for a central authority or a server.

In most modern public blockchains, transactions include-but are not limited to-value exchange with single or multiple signatures, decentralized applications, and smart contracts, all secured by the blockchain technology. Ethereum [2] was the first blockchain enabling decentralized applications (dApps), smart contracts, and Digital Autonomous Organizations (DAOs), while being capable of holding assets, transacting and communicating securely, without being controlled by a central authority. For transaction data (i.e., single transactions or blocks of transactions) to be added to the blockchain, all nodes of the whole network compete to validate a chunk of transaction data. Eventually, one node wins the competition: the network synchronizes and agrees on which node won the race-a process known as consensus. Forbidding double-spending, or more generally preventing transaction duplication, is one of the main fundamentals providing trust, giving values and irrefutable ownerships to assets (which are not necessarily of financial nature).

For public blockchains, the consensus validates new transaction data easily, but it is extremely difficult for an attacker alone to interfere with it, because he would need to re-calculate complete parts of the blockchain to manipulate it in order to gain an advantage. Blockchain securing is often based on a competition, a race, between many participating nodes, each of them having a certain (and very low) probability to validate transaction data, generally gathered in blocks. However, when all participants race together, new transaction data is eventually validated within a reasonably short time by one node, picked-up randomly (by construction). The successful node, i.e. the winner of the race, gains the right to add the new transaction data to the blockchain, usually a block of transactions, and is rewarded by tokens. This reward comes from transaction fees paid by users of the network, and from new token creation-this is how new tokens are generally created in a blockchain.

### Proof of Work (PoW)

Many consensus algorithms exist to validate blockchain transactions. The earliest and generally considered as the most secure consensus method, Proof-of-Work (PoW), is a method for validating transaction data, based on (generally) energy-intensive calculations validate transaction data. These calculations require a significant amount of electrical energy via computational power. The calculation done in PoW is generally a cryptographic one-way function (hash-code calculation) [3] applied repeatedly on the transaction data and a random number, until a condition is met: this ensures that a certain effort is provided on average to find the solution. This allows honest participants to find the solution together, but prevents isolated attackers from doing so, an approach called hashcash [4].

The participating node being rewarded by new tokens, this process referred to as mining, by analogy with gold mining: tokens are added to the network in the same way that the physical extraction of ore brings fresh gold to the market. The nodes of the blockchain network doing mining are called miners. Miners generally gather transactions in a block, and search for the solution based on hash-coding this block. The first miner which finds the solution (the winning miner) gains the right to add this block of transactions to the blockchain. At the same time, the winning miner receives tokens as a reward, coming from new token creation and transactions fees paid by the users of the network.

A condition is imposed to this hash-code calculation to makes finding a solution “difficult” enough for a miner, a concept named difficulty. For example, for Bitcoin, the first official blockchain and cryptocurrency invented in 2009 by Satoshi Nakamoto [1], the condition is that the hash-code must have a numerical value lower than a specified value. For Bitcoin many nodes try to solve the problem in parallel based on the calculation of the hash function SHA256, a hash function from the US National Institute of Standards and Technology (NIST) [5], applied twice. The first miner which finds the solution for some transaction data has the right to add it to the blockchain. The difficulty is updated on a regular basis (approximately every two weeks for Bitcoin), for example requiring a lower numerical value as the upper bound for the hash-code (for the Bitcoin network, one block is added every 10 minutes on average), despite the generally progressive increase of the global mining power over time. As mining hardware becomes more and more efficient, and the number of validating nodes (miners) increases, the difficulty is increased to maintain the same block validation rate.

PoW then indirectly links mining to time, using the amount of energy used as the link. It is today extremely unlikely to be profitable by mining Bitcoin with a single computer using its Central Processing Unit (CPU): since its creation, Bitcoin was rapidly mined by passionate people with Graphical Processing Units (GPUs), then Field Programmable Gate Arrays (FPGAs), and finally Application-Specific Integrated Circuit (ASIC) hardware, these being far faster than CPUs. Although not used for blockchains up to now, Tensor Flow Units (TPU) could be used also soon. Currently, huge mining farms of thousands of specific mining hardware processors are generating new coins, and many of them were, until recently, in China (before China's mining ban on its territory in May 2021). Mining farms are often built in countries or regions where electricity production is cheap enough to ensure some profit, thanks mostly to coal power plants and hydroelectric production or other renewables/waste sources. Cold regions are also favored, helping the cooling of the thousands of computing units of a mining farm without consuming too much energy. This makes cryptocurrencies like Bitcoin the target of increasing criticism, pinpointed as a non-green and dirty process. The fact that solving cryptographic hash code so intensively has no usefulness beside securing the blockchain does not help the case.

On the other hand, linking this calculation to energy makes the process highly secure: nobody can cheat on energy, meaning that a minimum amount of energy has to be spent to have a chance to validate some transaction data. This remains true until a method is developed to shortcut this calculation (SHA256 in case of Bitcoin)-and it is not known whether such a shortcut exists. Moreover, such one-way functions cannot be broken by future quantum calculators, according to current knowledge-and can even be strengthened against this if necessary. For this reason, PoW is considered to be the most secure way of securing a public blockchain.

### Proof of Stake (POS)

As an alternative to the high energy consumption issue of PoW, other consensus methods do exist, linking block validation to other criteria. A famous alternative to PoW is Proof-of-Stake (POS), which links transaction data validation to the participation of nodes: generally the amount of tokens engaged/locked up in the network, the duration of this engagement, etc. This process is called staking, minting or validating, rather than mining, since it relies on the validation (using cryptographic signature) [3] by participant nodes rather on some difficult and energy-consuming calculations. Participating nodes are further called stakers or validators. One the earliest cryptocurrencies implementing such consensus method is Peercoin. Since such an approach typically favors the richest people (those with the most of the particular cryptocurrency), other metrics can be used to reduce this bias-like decreasing the probability of transaction data validation when the time of token holding increases. Several variants of POS exist. One of the most famous blockchains and cryptocurrencies, Ethereum, successfully migrated from PoW to PoS on Sep. 15, 2022, as Ethereum 2.0, in a migration process called “The Merge” [6]. The big advantage of PoS is that validating a new transaction/block is not related to any amount of energy (besides the relatively small amount of energy used for calculations and inter-node communications), hence PoS appears as a better “environment-friendly” and “greener” consensus mechanism than PoW.

PoS is generally linked to the number of tokens held by participants, or validators. Those holding the largest amounts of tokens have the highest probability to win the consensus race. For this, validators should immobilize tokens for a predefined duration of time. Immobilizing tokens for PoS is staking, and PoS participants, or validators, are stakers. However PoS has its drawbacks. When simply based on the amount of staked tokens, it means that those tokens are immobilized during the duration of staking and cannot be used or traded, a duration which should be in general chosen in advance by the staker: in particular they cannot sell their coins in the case of a significant drop in price. Rich people just holding coins are favored as mentioned above, making the consensus unfair. On the other hand, when mechanisms are implemented to avoid this, holders may be unfavored since this would oblige them to “move” their coins more often, paying additional blockchain fees for each transaction, artificially increasing the transaction traffic.

A more important issue of POS is that, in order to increase the security of the network, parts of the total coin supply must be diverted from their regular use just to achieve staking. This is a problem if coins are supposed to be used in majority for selling/buying goods and services, as they are in a typical economy: a significant part of tokens would be immobilized. Finally, this method is purely algorithmic and is not linked to a physical process: PoS therefore cannot be not as secure as PoW. PoS has, nevertheless so far escaped a comprehensive threat model that encompasses both Byzantine attacks on distributed systems and financial attacks that arise from the dual use of the token as a mean of payment and a breach in resistance mechanism. Despite this, and mostly because of the supposed energy voracity of POW, more and more cryptocurrencies implement PoS today.

### Proof of Elapsed Time (PoET)

An energy-saving method should not rely on energy consumption to validate transaction data. In one sense, it can be argued that PoW links the consensus (indirectly) to a certain amount of elapsed time: the time needed to solve a complex mathematical problem, using some amount of energy. Therefore, an ideal approach is to link transaction/block validation directly to such an amount of elapsed time, but without dedicated energy consumption. This is known as Proof-of-Elapsed-Time (PoET) [7]. Similar to POS, the process for a node participating in a PoET consensus is minting, because it does not rely on the intensive computational power to solve a complex mathematical problem. PoET provides random distributions of “wake-up times” for the nodes in the network, with the node that “wakes up” first becoming the leader having the right to add transaction data to the blockchain or decentralized ledger, without the need to perform “useless” and energy-greedy calculations. The challenge, however, is to link mining or minting securely with time, which is not an easy task.

PoET has been implemented first by Intel, based on the set of consensus validators going to sleep for random durations of time. The main problem is: how to be sure that all participant nodes do really sleep for these random durations? It is necessary to prevent the random sleep delay from tampering, and to avoid malicious nodes artificially waking up with zero or little delay to always win the race. Intel uses the protected/privileged part of a processor and its clock for random sleeping, in which functioning cannot be altered by any non-privileged process. This part is named the Trusted Execution Environment (TEE). An example of PoET implementation is Hyperledger Fabric. However, this protection is purely technological: one has to trust Intel, to trust the processor, or be certain that the processor is not a counterfeited one. One has also to be confident that there is no way to hack the TEE, while the history of technology is full of cases where security flaws (or “exploits”) have been discovered, including in processors. These considerations suggest that TEE is perhaps not ideal when constructing a system based on trustlessness. This is probably why currently POET is used for permissioned/private blockchains only. A much safer method to guarantee elapsed times is required for the POET consensus method to be used for any blockchain or decentralized network/ledger: this is exactly what this invention is about.

The present invention is a variant of PoET, which can be advantageously deployed within constellations of satellites, and can be used to secure decentralized ledgers worldwide. This protocol works within and across various satellite networks using inter-satellite routing schemes, generating random numbers, electing random leaders for the purpose of the consensus, and providing agnostic handling of decentralized applications. Such consensus can service any Earth-based clients in a space-for-Earth paradigm, following the rapid development of the New Space economy [8] and the deployment of Internet by satellite like Starlink. Later, space-to-space economy will benefit from this invention.

### BRIEF SUMMARY OF THE INVENTION

The main embodiment of the invention consists of the fact that information traveling from one point to another cannot be transmitted faster than the speed of light, according to the theory of special relativity. For this purpose, this main embodiment forces a message to travel through a sequence of hops over at least two randomly chosen nodes (e.g., satellites). These hops occur over distances that are known and cannot be reduced below a minimum value. Consequently, it is possible to ensure that a minimum amount of time has elapsed. Messages carry proofs that they passed through a set of nodes, with each node adding a signature [3] to the message by any unambiguous method. When a node signs a message, all other nodes can verify the signature. Any asymmetric cryptographic signature can be used for this purpose. The total elapsed time does not even have to be quantitatively measured (e.g., in seconds), only the qualitative differences of elapsed times obtained by the different nodes are important to select the winning node. Any algorithm can be used to convert the cumuli of all transmission times between two hops in pairs of hops, into an estimate of the total elapsed time, depending on the general configuration of the network. Measuring some elapsed time by this method is particularly well-suited for deployment in space onboard artificial satellites since distances between satellites cannot be manipulated or reduced easily without being noticed. This results from the fact that satellites are constrained by Johann Kepler's laws. Consequently, a minimum elapsed time is guaranteed based on the fundamental laws of physics, rather than on technological guarantees which may be broken.

The main embodiment allows a variant of Proof-of-Elapsed-Time (PoET) consensus method to secure decentralized networks based on the theory of Special Relativity. While Intel's original PoET mechanism relies on the Trusted Execution Environment (TEE) of a processor, which is a technological-only (and breakable) protection, the alternate version of PoET disclosed in this invention is based on minimum elapsed time intervals resulting from the propagation of signals over distances that are known and irreducible. Since these distances are known and cannot be shortened below a particular value, the fact that no information can travel faster than the speed of light ensures a minimum elapsed time. The proposed variant of PoET disclosed here will be named “Space Proof-of-Elapsed-Time”, or “Space PoET”, in the following. Space PoET ensures that a minimum time has elapsed to determine a random leader to process transaction data, similar to what is achieved by PoW, but without any energy-greedy calculation thanks to the time taken by the propagation of messages between nodes.

The main embodiment further secures any algorithm or calculation producing a random seed, that possesses the property of a signal taking a minimum amount of time (a hop) and without using dedicated energy-intensive calculations. In particular, the main embodiment refers to the Slow-Timed Hop (SloTH) which is a signal between nodes in the network that cannot proceed faster than a certain minimum time based on Special Relativity. This is part of an algorithm generating an uncontestable and/or verifiable random seed and is used to prevent the manipulation of the random seed. The original version of this was the Slow-Timed Hash (also SloTH) which relied on a form of hashing that could not be sped up [9]. The Slow-Timed Hop is a relativistic alternative to the Slow-Timed Hash that does not use energy-intensive hashing and is post-quantum secure.

In all embodiments of the invention, entropy as a contribution to the generation of a random seed can be provided from certified sources [10], from any source of entropy resulting from a physical process. Thanks to specific hardware and sensors, entropy can also come from thermal noise, or from a Quantum Random Number Generator (QRNG). Entropy can also come from environmental noise like radio signals, magnetic fields, radiation, etc. Any other unpredictable physical processes can be used as sources of entropy.

In all embodiments of the invention, the method is ideal for constellations of satellites, preferably LEO satellites (although not restricted to this) and preferably able to communicate with each other: distances cannot physically be reduced under a certain limit, and are generally big enough to impose tens of milliseconds between each node, but short enough to get reasonable validation times. The finite speed of light, therefore, guarantees minimal elapsed times, whereby the range of these elapsed times will be determined by inter-satellite distances.

In other embodiments of the invention, the method is not restricted to space environment but can be applied on Earth too, in ground-based systems. In that case, distances are often shorter, but cannot be zero as explained below.

Distance between nodes are inevitably non-zero, since it is impossible to have distinct nodes validating messages exactly at the same location at the same time. Hence, distances between message-signing nodes will never be zero, and any signal will take a minimal time to travel between them. If all nodes are integrated in the same computer or on the same integrated chips, times can be as small as fractions of nano-seconds for under-millimetric distances, but still non-zero. Again, any algorithm can convert the total transmission times between nodes into a total elapsed time.

### BRIEF DESCRIPTION OF THE SEVERAL VIEWS OF THE DRAWINGS

FIG. 1: Representation of a constellation of satellites communicating with each other. Each satellite is hosting at least one decentralized network node and processes one hop for message transmission. (1) the satellites; (2) the satellite orbits, (3) inter-satellite communication links, used to propagate messages between hops to generate elapsed time from latencies; (4) the celestial object the satellites are orbiting, in this case Earth.

FIG. 2: Schematics of the generation of elapsed time based on the propagation of a message through a sequence of hops, typically processed onboard different satellites. (1) validating node, also considered as the host of hop 0, only one validating node and validation method being shown in this figure; (2) the transaction validating message used for elapsed time-based transaction data validation, to be propagated from node to node in a randomly chosen sequence; (3) the nodes which successively receive, sign and transmit the message; (4) node-to-node path followed by the message, following the arrows of the figure, arrows imposing a sequence of irreducible distances—i.e. time thanks to the theory of Special Relativity. Each node of (3) signs the message in order to guarantee that the message actually followed this sequence of hops; (5) are nodes not communicated with by the validating node (1). The node receiving the message after the hop sequence can be the same as the initial sending node, but this is not mandatory. In the consensus race, all nodes determine their wake-up time from a random probability distribution and send a signal over sequences of hops. The winning node could then be the node that manages to wake up first and propagates a signal over a sufficient number of other nodes, over a minimum distance, or a minimum elapsed time, or any other criterion.

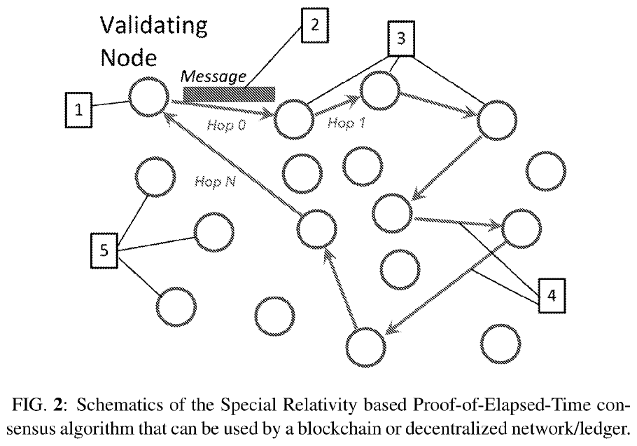

FIG. 3: Schematics of a hardware chip incorporated in the systems of a satellite, which allows for the operation of the Space Proof-of-Elapsed-Time (PoET) consensus mechanism. The hardware chip is located onboard a spacecraft (i.e., a satellite) and executes the decentralized protocols, stores decentralized data, and provides an independent source of entropy to the pseudorandom number generator (PRNG). The host spacecraft provides power, data routing, and entropy (via the spacecraft's onboard sensors) to the hardware chip. In return, the hardware chip allows the spacecraft to receive passive income from the decentralized networks operating on the hardware. The constituent parts of the hardware chip and its host spacecraft are as follows: (1) Entropy for the PRNG is provided by the spacecraft's onboard sensors (2) The hardware chip is located on the host spacecraft (e.g., a satellite) and communicates with it via the spacecraft's data bus (3) The entropy from the spacecraft's sensors is collected by the hardware chip's “satellite entropy pool” (4) The hardware chip has its own sensor—independent from the spacecraft's sensors—that provides an independent source of entropy to the PRNG (5) The local entropy pool that collects entropy from the hardware chip's sensor (6) The hardware chip (7) The Declination, Right Ascension, and DIStance (DRADIS) subsystem on the hardware chip allows the hardware chip to broadcast and receive radio signals from other (relatively) nearby hardware chips and constrain their distance and direction. This enables Sybil resistance within the space-based network (8) The radio transceiver for the DRADIS subsystem (9) The CPU on the hardware chip handles the execution of the decentralized protocols (10) Each hardware chip maintains a “Payload”, which is a novel data structure for decentralized data in the space environment (11) The CPU also maintains a pool of potential inputs (e.g., blocks, transactions) to the Payload data structure (12) The Pseudo Random Number Generator (PRNG) combines entropy from the satellite entropy pool and local entropy pool (13) The host spacecraft communicate via ground station relays and inter-satellite links (e.g., laser links) (14) The host spacecraft provides communication with other hardware nodes in the network through inter-satellite links.

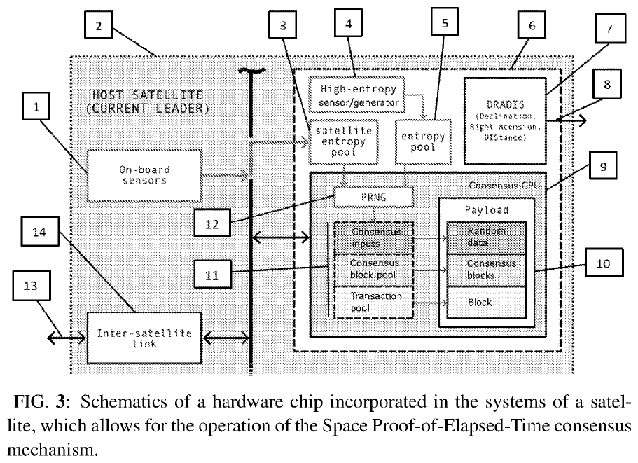

### DETAILED DESCRIPTION OF THE INVENTION

The main embodiment of the invention consists of a decentralized consensus mechanism, namely a novel version of Proof-of-Elapsed-Time (PoET) which we call Space-based Proof-of-Elapsed-Time (Space PoET). Space PoET is used to validate data on decentralized networks by ensuring information transmission (i.e. the amount of time needed to transmit information over some distance) requires a minimum interval of time. These minimum elapsed times are guaranteed by the finite speed of light as described by the theory of special relativity which stipulates that no information can travel faster than the speed of light. Such elapsed times are therefore secured by fundamental laws of physics, instead of performing some energy-consuming complex calculation (e.g., hashing) such as what is done under Proof-of-Work (PoW) schemes. Such guaranteed elapsed times secure the Space PoET protocol, as well as the calculation of uncontestable and/or verifiable random seeds which utilize minimum time computation without significant energy consumption.

Space Proof-of-Elapsed-Time (PoET) secured by the theory of special relativity The drawback of the original PoET consensus mechanism, as implemented by Intel, is that it requires a protected area of the computing chip (i.e., a Trusted Execution Environment; TEE). This means that the original PoET consensus mechanism is secured by a technological barrier only. The protected area is considered secure because it is not easy to read its content or interfere with the process of assigning “sleep times”. Unlike PoW which relies on the physical process of energy dissipation, the chip's protected area is not a fundamental physical limit. Advanced investigation methods could get secret information out of the chip, and use it to implement some rogue node which provides systematically the shortest elapsed time to win the POET consensus race in a blockchain or decentralized network/ledger. This is impossible to control over a public blockchain or decentralized network/ledger, in particular when such a blockchain or decentralized network/ledger is using diverse processors from heterogeneous manufacturers.

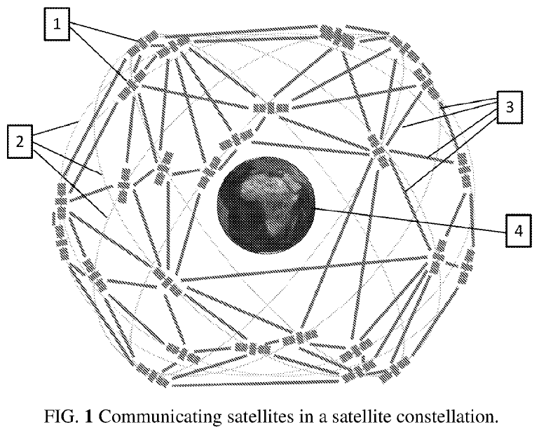

In its main embodiment, Space PoET relies on a fundamental law of physics: the impossibility to transmit any useful information, energy, or material faster than the speed of light. Space PoET uses the latency times occurring in inter-node communications, to get certified elapsed times. These latency times depend on distances between nodes, and minimum guaranteed elapsed times imposed by the finite nature of this impossible-to-exceed speed of light. This is especially obvious in satellite constellations, where nodes/hops are distributed over satellites. In its main embodiment, a validation message representing the transaction data is transmitted between nodes on different satellites via hops. Transmission can be direct between satellites, or relayed via ground-based stations. In this embodiment, since distances between satellites cannot be arbitrarily small, and as a consequence of special relativity stating that no information can travel faster than the speed of light in vacuum (c≈299'792'458 meters per second), irreducible intervals of time are imposed at each inter-satellite or satellite-ground transmission. Hence, this minimal inter-satellite transmission time is mapped to a fundamental lower limit in time. By having a sequence of different hops the transaction validating message has to pass through (hops being processed by nodes onboard different satellites), and by specifying or knowing the total number of hops in this path, and by making each node sign this message, one constructs the proof that this validating message actually passed through all these nodes, separated by irreducible distance—hence irreducible latencies, or irreductible elapsed times. This is illustrated by FIG. 1.

In its main embodiment, the invention further allows to secure any calculation of a random number or seed or probability distribution that utilises a minimum elapsed time component, and is used in Space PoET consensus. Specifically, this form of calculation or algorithm can be used for a relativistic version of the Slow-Timed Hash (SloTH), namely the Slow-Timed Hop (SloTH) without the need for energy-intensive calculations. The Slow-Timed Hash is used by a protocol which generates UNCOntestable Random Rumbers (UNICORN) [9]. Unbiased and truly random numbers are essential to any blockchain or decentralized network/ledger consensus, as well as any cryptographic process in general, in order to ensure their security. The UNICORN is a collusion-resistant protocol where anyone can verify that the output is not flawed or biased, with the security level being that of a single honest actor (if even only one contributor or contributing input is honest/unbiased, the resulting random seed will be truly random). The Slow-Timed Hop is a replacement for the Slow-Timed Hash that is ideally suited to a satellite network and is post-quantum secure.

According to various embodiments, a minimum elapsed time is guaranteed by the non-zero distances between satellites, between satellites and relays on Earth or anywhere else, as well as anywhere on Earth, on the Moon, or elsewhere in the cosmos. The advantage of satellite constellations is that their specific situation makes these distances extremely well known and extremely difficult to reduce, as well as impossible to reduce below a minimum value. Indeed, satellites move on orbits according to very precise laws of motion which are valid for artificial satellites or any orbiting object. Moreover, satellites are difficult to access physically, hence more difficult to attack and tamper with. For example, reducing distances between satellites in order to bias elapsed times would be impracticable and in some cases impossible due to the energetic cost of altering a satellite's orbit. Furthermore, the fact that satellites are in space makes them extremely difficult to tamper with physically.

In various embodiments of the invention, the relatively large distances between satellites (hundreds of kilometers at least) and the relatively pristine communication environment of space make the corresponding times relatively easy to measure. Minimum distances (and latencies) are constrained by the size of the object that is being orbited (Earth, Moon, any other Solar system object). For satellites in LEO, the minimum latency between two satellites cannot be less than dozens of milliseconds. In various embodiments of the invention, rapidly changing inter-satellite distances resulting from high-speed orbiting can help to make the resulting elapsed time more random, for a message passing through a sequence of hops.

In all embodiments of the invention, hereunder is described how this consensus method can work, by turning these incompressible latencies into a working Space PoET consensus method:
1. When a node verifies transaction data (transaction or a block of transactions), a transaction means any operation done in the ecosystem of a blockchain or decentralized network/ledger, and secured in the blockchain or decentralized network/ledger: it is for example the transfer of a value, the execution of a smart contract, or the execution of a decentralized application.
2. Space PoET requires a “validating message” (designed for this purpose) to be transferred from one node to the other, through a sequence of hops, with each node signing the validating messages as it proceeds through the hops. Each node is separated from other nodes by a minimum distance (i.e., where each node is on a different satellite). If the message passed through N hops, then it is proven that a minimum time has passed, according to latency times determined by the range of distances that exist physically between all pairs of nodes.
3. In order to maximize the chance that the validation message achieves a complete validation path, taking into account the possibility of unreachable nodes or non-working nodes, propagation fanning to multiple subsequent nodes can be carried out at each stage. This means that each node tries to forward the message to several subsequent nodes in parallel, to reduce the risk of an interrupted sequence. This is important to ensure that the final node has the highest possible chance to receive the validation message and to finalize the transaction data validation process.
4. Randomness of leader selection of the node processing or verifying the transaction data is ensured by uncontestable and/or verifiable true randomness from any algorithm that utilizes incorruptible entropy inputs or random paths between nodes.
5. Additional randomness of the elapsed time process can come from selecting a random number and/or a random path of hops N for each validation process.
6. Randomness of the elapsed time process is ensured by the fact that inputs to the algorithm calculating the random number or seed are extremely difficult to predict or bias, and that the true randomness of the output of the algorithm depends on only a single input being incorruptible or not manipulated.
7. Any random selection of hop path and/or number of hops N can be done either at the beginning of each validation process or progressively at the level of each hop, as the validation message passes from node to node.
8. It is possible that inter-node distances remain approximately constant during the time (e.g., a cluster of satellites with constant configuration, a fleet of drones flying in the Earth's atmosphere in a stable configuration, or nodes placed on the surface of the Earth, the Moon, or Mars for example). This may occur also if distances vary but are predictable, which is the case for constellations of satellites. This is why a random selection of hops paths and the number of hops introduce any needed additional randomness in the elapsed time process.
9. Any other method increasing the randomness of the final elapsed time (which results from the succession of inter-node transmission times) can be used.
10. Randomness is also used by any mathematical operation included in the Space PoET consensus, including cryptographic operation, to validate the transaction data, including (but not restricted to) signing the transaction validation messages along the sequence of hops.
11. All operations using randomness require a True Random Number Generator (TRNG) which provides true randomness. A Pseudo-Random Number Generator (PRNG), which provides arithmetically pseudo-random numbers from a “seed”, is not sufficient: pseudo-random number sequences are deterministic and could be predicted and regenerated, especially if the seed gets hacked: the consensus could be hacked and broken. However, a PRNG can be still be used in combination with a TRNG to improve the statistical distribution of this TRNG. It can be used with several TRNGs, combining them with the best distribution. In general, uniform distributions provide the highest security of cryptographic processes.
12. At least one TRNG is essential, and should rely on a true source of randomness, or a true source of entropy. Possible sources of true entropy are: a Quantum Random Number Generator (QRNG), or any sensor capturing unpredictable physical processes in-situ. In space, this latter source can be (but not restricted to) cosmic radiation, magnetic field variations, solar radiation, solar wind, cosmic gamma rays, radio-frequency emissions from Earth or from any cosmic object, etc. Sensors can be (but are not restricted to) antennas, thermal sensor, cameras, solenoids, pressure sensor, radiation detector, etc. In other environments like on Earth or elsewhere, this can be any unpredictable physical process resulting into unpredictable noise. This source of noise cannot be captured easily in situ or interfered with by an intruder, especially in the case of the space environment, making this process extremely secure. Several sources of entropy can be used, leading to several TRNGs, to minimize the loss of entropy. Combining several TRNGs together, which can be done through one PRNG, guarantees that the resulting random numbers remains truly random, even if all true entropy sources but one become flawed. Said differently, having only one TRNG functioning properly in a collection of TRNGs makes the system robust enough to guarantee true random numbers.
13. The random numbers can further be guaranteed thanks to a protocol that takes in contributions and outputs an uncontestable and/or verifiable random seed. This is particularly important to certify that random numbers generated by hops, or nodes, have not been tampered with. The Slow-Timed Hop used by this protocol to ensure security against manipulation of the output can use certified elapsed times from validation message transmission, as a relativistic version of the Slow-Timed Hash used by the standard UNICORN protocol for security against manipulation of the output. In general the uncontestable and/or verifiable random seed generation is extremely secure due to the requirement for only one contributor to be honest and/or not flawed in order for truly random seeds to be produced from the protocol.
14. To validate a transaction/block, a signal is sent between several validating nodes. Each validating node sends at least one transaction validating message through a sequence of hops that it may choose randomly, or that may be randomly selected on the fly, which forms part of any uncontestable/verifiable random number generating algorithm. This results in an unbiased random probability distribution of wake-up times. The node gets its respective wake up time from this distribution, which can be the shortest time in the probability distribution, or can be chosen based on any other criteria. Elapsed times for the sleeping/waking periods obtained by the different competing validating nodes will therefore be random: one node gets the shortest elapsed time, while the another gets the longest elapsed time; an exact measurement of actual elapsed times is not necessary, removing any possibility to cheat.
15. To select the winning validating node in the Space PoET consensus based on elapsed times, any algorithm can be used. The algorithm can come from, e.g., Graph Theory, with the sequence of N hops being a part of the graph formed by the constellation of nodes. For example, a random number of N of validating hops in a random order can be selected from a random number generator: the transaction validating message should pass through all N hops, taking a particular amount of time. Any algorithmic normalization of the total elapsed time can be used, the simplest approach being to divide the total latency obtained by the number N of traversed hops.
16. Each specific node in the sequence can be identified by a unique secret or private cryptographic key, which signs the transaction/block validation: if the transaction did not pass through that node, then it cannot be signed by it. Hence, each node signs a transaction validation message, then passes this message to the next node which will sign it as well, incrementally. It is easy to prove that the transaction/block actually passed through the complete sequence of nodes thanks to these signatures, hence ensuring a certain elapsed time.
17. Transaction-validating messages can use any algorithmic method, with the property of an asymmetric cryptographic scheme: a secret key or a private key is used to sign transaction-validating messages; the method can be a quantum-resistant cryptographic scheme.
18. In order to be node-dependent and kept secret for an individual node, this secret or private key is secretly stored in a protected chip, or algorithmically derived from any intrinsic physical properties/features of some electronic/photonic/optical components, which cannot be reproduced-even by the manufacturer of these components. Such intrinsic physical properties/features are called Physical Unclonable Features (PUFs). Such PUFs should be non-reproducible, but stable over time. For the case of satellites, each satellite would use its own secrete or private signing keys and/or PUF, which are never transmitted to other nodes or to other satellites.

The invention extends to apparatus comprising the following:
1. The Space PoET consensus method can, with the proper algorithm, effectively replace the PoW consensus or PoS consensus mechanisms for public and/or private blockchains and decentralized networks/ledgers, with any level of permission/permissionless architecture. For private blockchains or decentralized networks/ledgers, an algorithm similar to the one implemented by Hyperledger Fabric can be used. However, any algorithm linking a random elapsed time to the validation of transactions or blocks of transactions, or to some random number-generating procedure with a minimum time component can be used. Space PoET can be used for any public blockchains (like Bitcoin and Ethereum) and for private blockchains as well, or any public or private decentralized network/ledger. For example, it is possible to modify Bitcoin or Ethereum (or any PoW-based or POS-based blockchain) or an alternative version thereof, by replacing their PoW or PoS consensus with a Space PoET validating part, at least partly, and this could be applied on the level of the individual miner and/or validator.
2. The method can be extended by placing validating nodes (providing hops and/or transaction processing) in places in the Solar System other than in orbit of Earth. Nodes can orbit the Moon or any other planet of the Solar System, the natural satellite of a planet, the Lagrange point of any planet including Earth, any other object of the Solar System, or can orbit the Sun. Nodes (providing hops and/or transaction processing) can also be placed directly on the surface of the Moon, of asteroids, or any other Solar System objects. Some validating nodes (providing hops and/or transaction processing) can even be placed on Earth, while others can be placed elsewhere in space or in the Solar System. The consequence of this can be larger elapsed times, resulting in longer transaction data validation times-but there is no fundamental limit for this, besides the practical aspect to keep delays reasonably short with respect to the application.
3. In the case of satellites, and although an absolute base of time is not necessary, onboard atomic clocks can be used to provide accurate time stamps.
4. In the case of satellites, although this is not required, these satellites can also get accurate positions and time data from existing GNSS, GPS, Galileo, or equivalent space-based time-providing/position-providing systems.
5. Although already extremely secure by itself, this latency-based Space PoET consensus can be extended by Artificial Intelligence (AI) techniques or statistical analysis in order to detect cheating nodes (i.e., nodes that would win the validation race significantly/artificially more often than expected by unbiased statistics) and exclude these cheating nodes from the network. Specialized hardware can be used for this, like a TPU.
6. If consensus is executed onboard of satellites, it typically relies exclusively on the energy from solar power, thanks to solar panels. Therefore, in that case, this is a fully “green” consensus mechanism that does not depend on Earth's resources. If nodes are deployed in deep space, where solar power becomes insufficient, nuclear energy (from a radioisotope thermal generator—RTG—or from a nuclear fission reactor) is a very probable alternative. In the future, nuclear fusion energy could be envisioned. Another alternative is beamed energy using an Earth-based laser or any space-based source. The method of power generation is not restricted to these sources of energy.

Before building and launching actual satellites, the method can be developed and tested thanks to satellite constellation simulation tools simulating these latencies realistically. Such a tool is called a Satellite Network Emulator, implementing the low-level and high-level network protocols while simulating the latencies, jitter, and other effects of a virtual satellite constellation.

### Proof-of-Elapsed-Time (PoET) Secured by the Theory of Special Relativity

In all embodiments of the invention, the method can also work in any environment with imposed latency times, and is not restricted to space. Although the space environment adds security by guaranteeing predictable minimum distances, unbiased and incorruptible sources of entropy, a pristine communication environment, and physically difficult-to-access nodes, the method can be applied to every collection of validating nodes, where these nodes are physically distinct. These nodes could run fully on Earth, or another suitable solar system body, like the Moon, or Mars. The collection of nodes can be collections of computers, smartphones, or any devices, working in a peer-to-peer manner, with the only constraint that the consensus should prove that the different nodes traversed by a transaction validating message are physically different nodes. Nodes can exist, for example, within an organization, or over the Internet. The only difference between these examples to space-based networks are the advantages of the space environment as outlined above. However, this is not a fundamental issue to the theoretical and practical functioning of such a network.

Even if nodes are within the same computer but implemented by different processors, Special Relativity imposes very short times of a fraction of nanoseconds at the speed of light to transfer a transaction-validating message from one node to another node. Even in a multi-processor computer or a multi-threading processor, two different calculations cannot take place physically exactly at the same place and at the same time. Consequently one can consider that Space POET is secured by special relativity, which cannot be circumvented under the known laws of physics. Two validating nodes with their respective private keys, processors, pipelines, memories, or any calculation units, being made of material particles, cannot be simultaneously at the same location—imposing a minimal distance—hence a minimal time—between two nodes. Moreover, the validation algorithm can be made complex enough to require a minimum number of computing units (processor pipeline, memory, buses, etc.)

### Devices and Systems Implementing the Method

In all embodiments, the invention comprises also all devices and equipment needed to implement and deploy this invention. They include satellites, and the following (but are not limited to) components that enable this Space PoET based on the theory of special relativity, including the power source providing energy to the satellite, the avionics, and payload:
Photovoltaic solar panels, RTG, nuclear fission reactor, nuclear fusion reactor, beamed laser energy from any ground-based or space-based artificial source.
Radio-frequency emitters, receivers, and antennas to transmit data.
Optical communication systems based on IR, visible or UV lasers, emitting and receiving laser diodes, to transmit data
Onboard computers with any kind of processors (CPU, GPU, FPGA, TPU, etc.), memories, hard-drives, buses, for the algorithms of the consensus mechanism, preferably hardened against cosmic rays.
Possibly atomic clocks to get a base of time.
Entropy sources to provide true randomness: Quantum Random Number Generators (QRNGs), sensors for: solar light radiation, solar wind, radio-frequencies, gamma-rays, charged particles like protons, electrons, positrons, heavy ions, etc. Sensors can be: antennas, optical sensors, radiation detectors, etc.
Possibly space-generated positioning signals like GNSS, GPS, Galileo, or equivalent space-based time-providing/position-providing system.
Wire connections between the onboard computer, the emitter, receiver, the quantum random number generator (for example).

For Earth and space-based Space PoET based on the theory of special relativity, the following can be included in all embodiments (but not limited to):
Computers with processors, memories, hard drives, buses, for the algorithms of the consensus mechanism.
Communication means to connect the nodes to other nodes: cables, optical fibers and protocols (Ethernet, 10G), mobile communications (3G, 4G, 5G).
Connection to reliable time servers, or atomic clock, to get a base of time.
QRNG to get true randomness; use of any sensor to get noise from the environment: thermal sensor, optical sensor, magnetic field sensor, ionizing radiation detector, etc.; connection to a reliable true random number generator server.

### REFERENCES

[1] Satoshi Nakamoto. Bitcoin: A peer-to-peer electronic cash system. Cryptography Mailing list at https://metzdowd.com, March 2009. https://bitcoin.org/bitcoin.pdf.
[2] Vitalik Buterin. A next generation smart contract & decentralized application platform. Ethereum white paper, 2013. https://cryptorating.eu/whitepapers/Ethereum/Ethereum_{w}hiteₚaper.pdf.
[3] A. M. Parker. Differences between hash functions, symmetric asymmetric algorithms. CryptoMathic, October 2017. https://www.cryptomathic.com/news-events/blog/differences-between-hash-functions-syn
[4] Adam Back. Hashcash-a denial of service counter-measure. http://www.cypherspace.org/hashcash/.
[5] NIST. Hash functions. Information Technology Laboratory, Computer Security Resource Center, June 2020. https://csrc.nist.gov/projects/hash-functions.
[6] Crypto Valley Journal. The ethereum merge: everything you need to know. Crypto Valley Journal, September 2022. https://cvj.ch/en/education/basics/the-ethereum-merge-everything-you-need-to-know/.
[7] Mic Bowman, Debajyoti Das, Avradip Mandal, and Hart Montgomery. On elapsed time consensus protocols. Cryptology ePrint Archive, (2021/086), January 2021. https://eprint.iacr.org/2021/086.
[8] Erik Kulu. In-space economy in 2021-statistical overview and classification of commercial entities. 72nd International Astronautical Congress (IAC 2021), (IAC-21-D3.3.10), October 2021. https://www.factoriesinspace.com/graphs/In-Space-Economy-2021_{E}rik-Kulu₁AC2021. pdf.
[9] Arjen K. Lenstra and Benjamin Wesolowski. A random zoo: sloth, unicorn, and trx. Cryptology ePrint Archive, (2015/366), 2015. https://eprint.iacr.org/2015/366.

Joseph Bonneau and Valeria Nikolaenko. Public randomness and randomness beacons. al6zcrypto, October 2022. https://a16zcrypto.com/public-randomness-and-randomness-beacons/.

What is claimed is:

1. A method for Proof-of-Elapsed-Time (PoET), a consensus method used to secure the transaction data of blockchains and/or decentralized networks/ledgers, based on the theory of special relativity which stipulates that no information, energy, or material can travel faster than the speed of light in vacuum. The elapsed time, i.e. the transmission time of a signal that secures the random distribution that determines the sleeping time of a node participating to the consensus in this version of PoET, comes from the transmission time of information between at least two different validating nodes, separated by irreducible distances. The sleeping time of a node in PoET replaces the energy-consumption-dependent time of Proof-of-Work (PoW). Such inter-node transmission time is also referred to as latency time, or latency. Hereunder, this version of PoET method is called: Space Proof-of-Elapsed-Time, or Space PoET; and the speed of light in vacuum is simply referred to as: the speed of light.

2. The method of claim 1 wherein information transmitted between at least two nodes, as a validating message, which contains a random seed and other specific meta-data to support the estimation of the final elapsed time, and is transmitted at least from a first node to a second node. The message can further be re-transmitted from the second node to a third node, and so on. The sequence of nodes traversed by the validating message is the hop path, and the last node to receive the message is the final node which will evaluate the final elapsed time.

3. The method of claims 1 and 2 wherein the validating message can be re-transmitted from the current node, with propagation potentially fanning to several other nodes, in parallel. For this purpose, a random selection of one or more subsequent nodes is carried out, to increase the randomness of the final elapsed time, and to reduce the risk of hop-path interruption resulting from the fact that some nodes may be inactive, down, or unreachable, from any current node. Propagation fanning largely minimizes the risk that any hop-path fails in finalizing a validation.

4. The method of claims 1 and 2 wherein the validating message can be re-transmitted through a random number of successive hops in the hop-path, ranging from 2 to N, with N greater or equal to 2.

5. The method of claims 2, 3 and 4 wherein the random selection of hop-paths, subsequent hops, number of hops N, can be done either at the beginning of the full hop-path transmission of the validating message, or progressively from node to node following a random-walk approach.

6. The method of claims 1, 2, 3, 4 and 5 wherein the final node which evaluates the final elapsed time of the hops can be the same as the first node of the node path, or can be a different node. In the latter case, the first hop and the last hop can be processed by the same node, or by two different nodes.

7. The method of claims 1 and 2 wherein nodes are the fundamental computing entities which achieve the elements of providing security against manipulation for the random selection of an elapsed amount of time, or latency, for the wake-up times of nodes, and a minimum elapsed amount of time between all pairs of nodes, and/or accumulated amount of time, latency, along all nodes traversed by the message. Each node signs the validating message to prove that it passed through it, and modifies the validating message accordingly to store this proof, storing at least the signature corresponding to this node, as well as any metadata that can help to estimate the final elapsed time by the final node.

8. The method of claims 1, 2 and 7 wherein each node signs the validating message that passed through it using its own secret data, which is kept internally and is never revealed to other nodes or external entities. However, this node will publish, in some way, public data allowing any external entity to verify that it actually signed the passing message. This is an asymmetric cryptographic signature, with private key kept internally by the node, while the public key can be used by all other nodes to verify the signature-proving that the message actually passed through the aforementioned node.

9. The method of claims 1, 2, 3, 4, 7 and 8 wherein the final node receiving the validating message gets the complete sequence of actually traversed nodes, certified by the respective signatures of each node stored in the validating message, which each node can verify using the public key of each traversed node. The final node is able to estimate a total elapsed time, thanks to signatures and metadata contained in the validating message, which is also verifiable by any node participating to the consensus, thanks to the nodes' public data/public keys.

10. The method of claims 1, 2, 3, 4, 5, 6, 7, 8 and 9 wherein such estimated elapsed times further secure any calculation of a random number, seed, or any message distribution. Such calculations can be used for a relativistic version of the Slow-Timed Hash (SloTH), namely the Slow-Timed Hop (SloTH), without the need for energy-intensive calculations, by using the minimum time requirement to prevent last-draw attacks that bias the generation of the random number or seed, via a time asymmetry between the commit and output phases of an UNCOntestable Random Number (UNICORN) protocol, a collusion-resistant protocol which can guarantee un-flawed and un-biased random outputs, even if there is only one honest actor in the contribution phase.

11. The method of claims 1, 2, 3, 4, 5, 6, 7, 8, 9 and 10 wherein all random numbers or message distributions used by the node participating in the consensus, in cryptographic algorithms, in the selection of the next hop, in the determination of the number of nodes, and any other procedure requiring randomness, is determined from the contributions of at least one entropy source to an uncontestable and/or verifiable random distribution, combined from at least one True Random Number Generator (TRNG), possibly combined with a Pseudo Random Number Generator (PRNG) to improve statistical distribution.

12. The method of claim 11 wherein the source of true entropy can be any unpredictable and erratic physical process measured in-situ, such as (but not limited to): thermal noise, radio-waves, electric fields, magnetic fields, solar light, ionizing-radiation (protons, electrons, heavy ions, X-rays, gamma-rays), wind, water flows, etc. It can also be any internal entropy generator independent from the location as a thermal random numbers generator, lava-lamp based random numbers generator, or Quantum Random Number Generator (QRNG). It can be also any external server providing true random numbers, assuming the quality of its entropy is trusted, and accessible by any communication link.

13. The method of claims 7, 8 and 12 wherein the cryptographic signature method, the UNICORN protocol which guarantees unflawed and unbiased random outputs, and any cryptographic-based method, can use quantum-resistant cryptographic methods, i.e. methods which cannot be cracked by any quantum computing algorithm, now or in the future.

14. The method of claims 7 and 8 wherein the secret data used by each node to sign validation messages (such as the secret key or private key) used to sign the validating message is possibly algorithmically derived, at least partly, from any intrinsic Physical Unclonable Features (PUF) of some electronic/phonic/optical hardware, which cannot be reproduced-even by the manufacturer of this said hardware. PUFs are random and unpredictable from one node to another node, but remains stable in time for an individual node, so that the PUF of an individual node uniquely identifies this node and no other. The PUF of one specific node is further kept secret/private, it is never communicated outside of this node.

15. The method of claims 1, 2, 7, 10 and 11 wherein hops, and nodes processing, sending, or receiving hops, can exist in any environment where distances between nodes exist. This includes satellites in a satellite network, including (but not restricted to) Low Earth Orbit (LEO), Medium Earth Orbit (MEO), or GEOstationary Orbit (GEO), satellites or stations orbiting the Earth, the Moon, the Sun, Mars, asteroids, etc. Nodes can also be placed on the surface of these objects, including being ground-based on Earth. Nodes can be placed in a fleet of vehicles, drones, planes, boats, trucks, trains, cars, etc. Nodes can even placed within the same building, or within a computing device (a computer), a Printed Circuit Board (PCB), a processor, as long as inter-node distances do exist and are guaranteed to be above some minimal value.

16. The devices achieving the functionalities of claims 1, 2, 3, 4, 5, 6, 7, 8, 9, 10, 11, 13 and 14, i.e. performing all the computations, data storage, sending and receiving of validating messages, as well as tasks required for the Space PoET. This hardware comprises a processor to do all calculations required by Space PoET, a memory to store the software implementing Space PoET, a memory to store at least temporarily the validating messages and other data, at least one clock to drive all these components, buses to link the different components between them. This hardware can be in one element (one PCB, one chip), or split into several components and linked by communication buses.

17. A central computing unit according to claims 1, 2, 3, 4 and 16 able to perform all required calculations of algorithms involved in the Space PoET consensus, generally a chip. In can be (but not limited to): a Central Processing Unit (CPU), a Graphical Processing Unit (GPU), a Field-Programmable Gate Array (FPGA), a Tensorflow Processing Unit (TPU), or an Application-Specific Integrated Circuit (ASIC).

18. The devices and hardware according to claims 1, 2, 3 and 4 allowing the communications of validating messages from node to node, adapted to use any of transmission carriers. It can be (but not limited to): copper cables, optical fibers, radio-frequency emitter/receivers, maser emitter/receivers, infrared (IR), visible or ultraviolet (UV) laser emitter/receivers, sound waves. Satellite communications can use: wireless communication such as radio-frequency thanks to antennas, light thanks to laser emitter/receivers, etc. Inside the same computing device, digital data can be transmitted over internal wires, sockets in a chip, or communication buses.

19. The devices according to claims 1, 2, 3 and 4 performing the modulation/demodulation (modem) to convert digital information to analogue signal to be transmitted and vice-versa, using any suitable protocol. It can be (but not limited to): ADSL, Ethernet, Internet, TCP/IP, UDP, WiFi, LiFi, 3G/4G/5G, HF, VHF, UHF, laser communication protocols, etc. Inside the same computing device, modulation/demodulation may not be needed however.

20. The devices according to claims 1, 6, 7, 10, 11 and 12 permitting the connection to any auxiliary sources of data useful for the consensus. Such data can be (but not limited to): Global Navigation Satellite System (GNSS) like: GPS, Galileo or GLONASS, to get current time and location; on-line time servers on the Internet to get current time; connection to TRNG servers or devices to get reliable random numbers (noise sensors, QRNG, etc.); connection to a clock (atomic clock).

21. The devices according to claims 1, 6, 7, 10, 11 and 12 to be used as sources of true entropy, which can be (but not limited to): any thermal, optical or quantum entropy generators (like QRNG); any sensor, such as optical sensor, thermal sensors, complete IR/visible/UV optical camera, ionizing radiation detectors, charged particle detectors, magnetic field sensors, radio-frequency receivers.

22. The specific hardware according to claim 14, embedded within each node, providing PUF for this node. This can be (but not limited to): an electronic chip, an optical generator, a thermal generator, having some intrinsic defects which cannot be reproduced even by the manufacturer of this device, and for which theses defects can be read and used as a specific “fingerprint”. This specific node hardware is securely embedded within the node.
